(19) United States
(12) Patent Application Publication
(10) Pub. No.: US 2024/0270082 A1
(43) Pub. Date: Aug. 15, 2024

(54) SYSTEM AND METHOD FOR ELECTRIC TRAILER TOWING

(71) Applicant: Ford Global Technologies, LLC, Dearborn, MI (US)

(72) Inventors: Mahmoud Ghannam, Canton, MI (US); Aed Dudar, Canton, MI (US); Christopher Storms, Madison Heights, MI (US)

(73) Assignee: Ford Global Technologies, LLC, Dearborn, MI (US)

(21) Appl. No.: 18/167,820

(22) Filed: Feb. 10, 2023

(51) Int. Cl. B60L 15/20; B60L 58/12; B62D 59/04

(52) U.S. Cl. CPC B60L 15/20; B60L 58/12; B62D 59/04; B60L 2240/26; B60L 2240/463; B60L 2240/54; B60L 2240/647

(57) ABSTRACT

A system to control a trailer is disclosed. The trailer may be attached to a towing vehicle. The system may include a transceiver configured to receive road information, vehicle information and trailer information. The system may further include a processor configured to determine that a predefined condition may be met based on the received road information, the vehicle information, and the trailer information. The processor may be further configured to transmit a command signal to a trailer wheel control unit to activate a trailer wheel drive motor responsive to a determination that the predefined condition is met. The trailer wheel drive motor may be located in a trailer.

### FIELD

The present disclosure relates to systems and methods for electric trailer towing and more particularly to systems and methods for controlling operation of electric trailer drive motors and wheels to optimize power consumption in a towing vehicle.

### BACKGROUND

Trailers are used in transportation industry to transport goods across long distances. Trailers are typically attached to towing vehicles that drive the trailers. Trailers have cargo space in which users may store goods to be transported, and the towing vehicles include internal combustion engines and/or batteries that may provide power to drive the trailers. Trailers can also be in the form of Recreation Vehicles (RVs) that may not necessarily be used to transport cargo, but may be used for recreational activities.

Towing a trailer may consume considerable vehicle power and cause significant drag on a towing vehicle, regardless of whether the towing vehicle is an Internal Combustion Engine (ICE) vehicle or a Battery Electric Vehicle (BEV). Increased consumption of vehicle power may affect vehicle mileage or range. Further, the towing vehicle may have to expend additional power if the trailer is heavy or carries heavy cargo or if the trailer is equipped with accessories, such as air conditioning, heater, etc. In addition, significant vehicle power may be consumed if the towing vehicle tows the trailer in harsh weather conditions or on challenging roads, e.g., on muddy or snowy roads.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts an example system for controlling a trailer attached to a vehicle in accordance with the present disclosure.

FIG. 3 depicts a snapshot of a vehicle and a trailer travelling on an upgraded road in accordance with the present disclosure.

FIG. 4 depicts a snapshot of a vehicle and a trailer travelling on a challenging road in accordance with the present disclosure.

FIG. 5 depicts a snapshot of a vehicle and a trailer executing a backing operation in accordance with the present disclosure.

FIG. 6 depicts a snapshot of a vehicle and a trailer travelling on a downgraded road in accordance with the present disclosure.

FIG. 7 depicts a flow diagram of an example method for controlling a trailer in accordance with the present disclosure.

### DETAILED DESCRIPTION

### Overview

The present disclosure describes a system and method for controlling an electric trailer attached to a towing vehicle. The trailer may include a wheel drive motor associated with each trailer wheel. The trailer may move by using power drawn from trailer batteries or the towing vehicle or by using mechanical “pull” of the towing vehicle. The system may be configured to control operation of each trailer wheel drive motor (and hence movement of each trailer wheel) based on information received from the trailer and the towing vehicle. For example, the system may activate or deactivate each trailer wheel drive motor and/or control torque and rotation angle of each trailer wheel based on the received information. The system may further cause each trailer wheel drive motor to operate by using power drawn from the trailer batteries based on the received information. In this manner, the system may cause trailer movement without using power drawn from the towing vehicle or using vehicle's mechanical pull.

In some aspects, the system may receive information associated with trailer weight, trailer battery State of Charge (SoC), presence of trailer regenerative braking mode, etc. from the trailer. Similarly, the system may receive information associated with vehicle weight, vehicle battery SoC, wheel torque and rotation angle for each vehicle wheel, etc. from the towing vehicle. The towing vehicle and/or the trailer may also include road condition detection sensors that may detect condition of road on which the vehicle and the trailer may be travelling. The system may receive road condition information from the sensors.

The system may control trailer wheel drive motor operation based on the received road information, the vehicle information, and the trailer information. For example, the system may activate the trailer wheel drive motor and cause the trailer to move by drawing power from the trailer batteries when the system determines that the towing vehicle and the trailer may be travelling on an upgraded road or a road with snow, mud, sand, etc. on it. The system may additionally activate the trailer wheel drive motor when the trailer weight is greater than a weight threshold. The system may further activate the trailer wheel drive motor when the vehicle battery SoC is less than a SoC threshold, or when the vehicle is performing backing operation.

In some aspects, the system may additionally control torque and rotation angle of each trailer wheel when the system determines that the vehicle and the trailer may be travelling on snowy or muddy road, or when the vehicle may be performing backing operation. The system may control trailer wheel torque and rotation angle such that movement of each trailer wheel may be aligned with movement of each vehicle wheel. This may ensure that the towing vehicle and the trailer stably move on snowy or muddy road, or a vehicle operator conveniently reverses the towing vehicle and the trailer.

In additional aspects, the system may deactivate the trailer wheel drive motor and cause the trailer to not use the trailer batteries when the system determines that the towing vehicle and the trailer may be travelling on a downgraded road. In this case, if the trailer has regenerative braking mode, the trailer may harvest kinetic energy while travelling on the downgraded road, and store harvested power in the trailer batteries. In some aspects, the system may cause transfer of stored power from the trailer batteries to the towing vehicle (e.g., to vehicle batteries) based on vehicle user inputs or when the vehicle battery SoC is less than a preset threshold.

The present disclosure discloses a system and method that facilitates in conserving vehicle power when a vehicle tows a trailer. The system may cause the trailer to move by using its own batteries, and may hence conserve vehicle power that may have been spent “pulling” the trailer. The system may further control torque and rotation angle of each trailer wheel such that the trailer may stably “follow” vehicle movement, and may thus assist in preventing the trailer from skidding or wavering.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

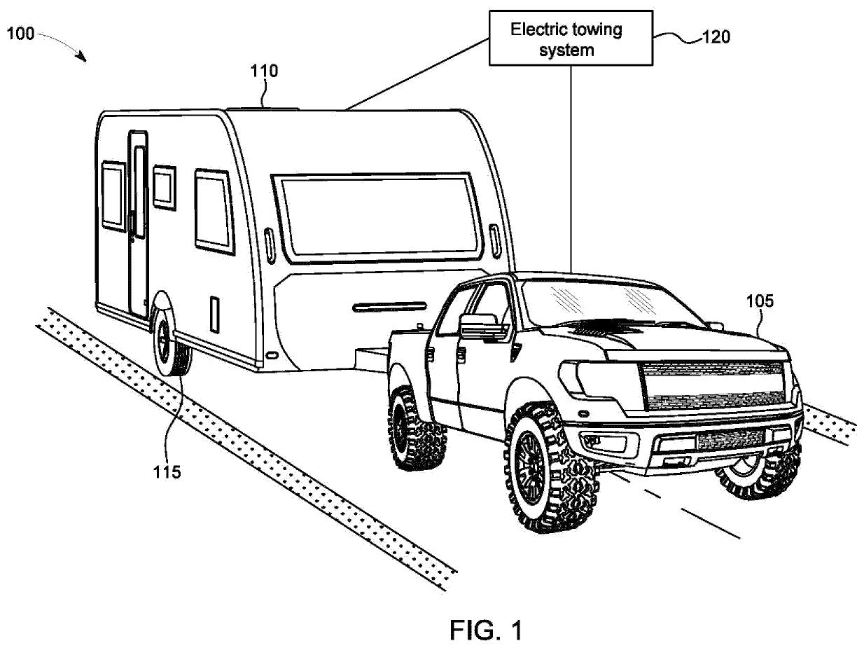

FIG. 1 depicts an example environment 100 in which techniques and structures for providing the systems and methods disclosed herein may be implemented. The environment 100 may include a towing vehicle 105 (or a vehicle 105) attached to a trailer 110. The trailer 110 may be attached to a vehicle rear portion, as shown in FIG. 1. In particular, the trailer 110 may be attached to the vehicle rear portion by using mechanical, electrical and/or magnetic fasteners.

The vehicle 105 may take the form of any passenger or commercial vehicle such as, for example, a car, an off-road vehicle, a work vehicle, a crossover vehicle, a van, a minivan, a taxi, a bus, a truck, etc. Further, the vehicle 105 may be a manually driven vehicle, and/or may be configured to operate in partially or fully autonomous mode, and may include any powertrain such as, for example, a gasoline engine, one or more electrically-actuated motor(s), a hybrid system, etc. In an exemplary aspect, the vehicle 105 may be a Battery Electric Vehicle (BEV). In other aspects, the vehicle 105 may be an Internal Combustion Engine (ICE) vehicle. Hereinafter, the description describes an aspect where the vehicle 105 is a BEV, however the description should not be construed as limiting and the present disclosure may be applied to ICE vehicles as well.

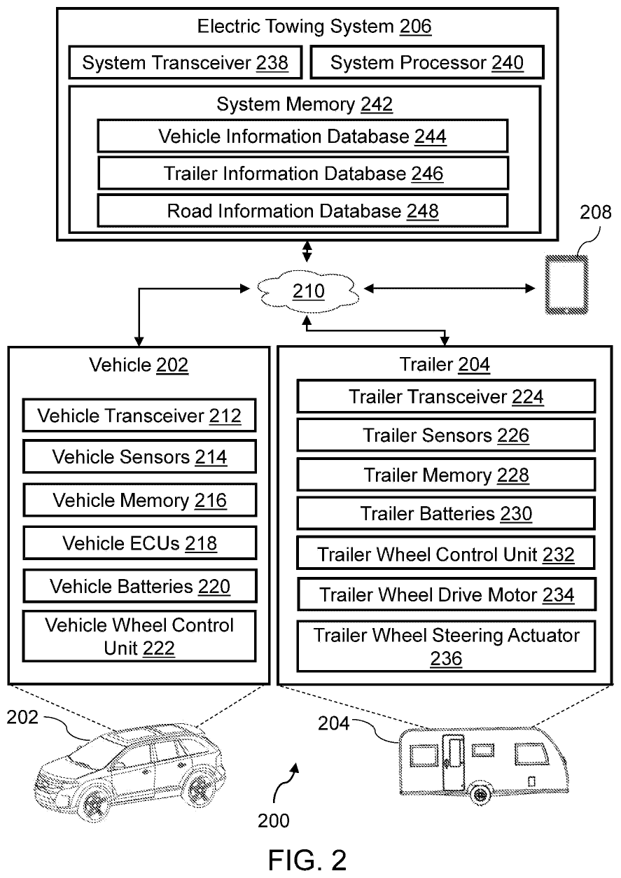

The trailer 110 may be a cargo trailer that may be used to transport goods, or may be a Recreational Vehicle (RV). In some aspects, the trailer 110 may be an electric trailer having one or more trailer batteries (shown as trailer batteries 230 in FIG. 2). The trailer 110 may operate (e.g., move on a road network) when the vehicle 105 “pulls” the trailer 110 from the vehicle rear portion, or by drawing power from vehicle batteries (shown as vehicle batteries 220 in FIG. 2). The trailer 110 may also operate by drawing power from the trailer batteries. Stated another way, the trailer 110 may move by using the “pull” from the vehicle 105 or drawing power from the vehicle batteries, or may move on its own by using trailer battery power. Further, the trailer 110 may include one or more accessories (not shown), for example, air conditioning, heater, lighting, etc. The trailer 110 may activate the accessories by using power drawn from the vehicle batteries or the trailer batteries.

In some aspects, the trailer 110 may include independent trailer wheel drive motor (shown as trailer wheel drive motor 234 in FIG. 2) and trailer wheel steering actuator (shown as trailer wheel steering actuator 236 in FIG. 2) for each trailer wheel 115. For example, if the trailer 110 has four wheels, the trailer 110 may include four independent trailer wheel drive motors and four independent trailer wheel steering actuators. Similarly, if the trailer 110 has two wheels, the trailer 110 may include two independent trailer wheel drive motors and two independent trailer wheel steering actuators. The trailer wheel drive motors and the trailer wheel steering actuators may operate by using power drawn from the trailer batteries (or from the vehicle batteries).

Each trailer wheel 115 may be configured to move independently of other trailer wheels by using respective trailer wheel drive motor and steering actuator. For example, left trailer wheel may be configured to move with a different torque and rotation angle than torque and rotation angle of right trailer wheel. In some aspects, a trailer wheel drive motor may activate a trailer wheel movement (e.g., movement in forward or backward direction) and control trailer wheel torque (or speed). A trailer wheel steering actuator may control trailer wheel rotation angle.

The environment 100 may further include an electric towing system 120 that may communicatively connect with the vehicle 105 and the trailer 110. In some aspects, the electric towing system 120 may be located inside the vehicle 105 and may be part of, for example, on-board vehicle computing system. In other aspects, the electric towing system 120 may be located inside the trailer 110 and may be part of, for example, on-board trailer computing system. In yet another aspect, the electric towing system 120 may be hosted on a remote server (not shown) that may communicatively connect with the vehicle 105 and the trailer 110.

The electric towing system 120 may control operation of the trailer wheel drive motors and/or the trailer wheel steering actuators to optimize vehicle 105 power consumption. Specifically, the electric towing system 120 may cause the trailer 110 to operate by using its own trailer batteries (as opposed to drawing power from the vehicle batteries, or moving by using the mechanical “pull” from the vehicle 105) when one or more predefined conditions are met. For example, the electric towing system 120 may switch ON the trailer wheel drive motors and cause the trailer 110 to use its own trailer batteries when the vehicle 105 and the trailer 110 are travelling on an upgraded road, e.g., during an uphill journey. This may help save vehicle 105 power, as considerable vehicle power may be consumed to “pull” the trailer 110 uphill. In a way, the electric towing system 120 may enable the trailer 110 to move on its own (i.e., itself act as an electric vehicle) by activating the trailer wheel drive motors, thus saving vehicle 105 power that may have been consumed in pulling the trailer 110.

In additional aspects, the electric towing system 120 may switch ON the trailer wheel drive motors (and cause the trailer 110 to use its own trailer batteries) when the vehicle 105 and the trailer 110 may be travelling on a challenging road, e.g., muddy or snowy road. In other aspects, the electric towing system 120 may switch ON the trailer wheel drive motors when State of Charge (SoC) of the vehicle batteries indicates low charge (e.g., lower than a threshold). In this case, the electric towing system 120 may switch ON the trailer wheel drive motors (and cause the trailer 110 to use its own trailer batteries) to ensure that the trailer 110 does not use the pull from the vehicle 105 to move the trailer 110 and/or consume vehicle battery power, thus assisting in optimizing vehicle power consumption.

The electric towing system 120 may additionally switch ON the trailer wheel drive motors and cause the trailer 110 to use its own trailer batteries based on vehicle operator inputs. For example, the vehicle operator may input a command on a user device or a vehicle Human-Machine Interface (HMI, not shown) to switch ON the trailer wheel drive motors, when the vehicle operator desires to save vehicle battery power. In this case, the user device or the vehicle HMI may transmit the command to the electric towing system 120, and the electric towing system 120 may switch ON the trailer wheel drive motors responsive to receiving the command.

In additional aspects, the electric towing system 120 may be configured to control operation of each trailer wheel steering actuator and trailer wheel drive motor to ensure that rotation angle and torque (e.g., speed) of each trailer wheel 115 is optimum, based on vehicle 105 driving condition and/or operation mode. For example, the electric towing system 120 may control rotation angle and torque of each trailer wheel 115 such that movement of each trailer wheel 115 may be aligned with vehicle 105 wheel movement, when a user performs vehicle backing operation (e.g., when the user reverses the vehicle 105 and the trailer 110). As another example, the electric towing system 120 may control rotation angle and torque of each trailer wheel 115 when the vehicle 105 and the trailer 110 may be travelling on muddy or snowy road, so that vehicle 105 and trailer 110 movement is steady, and the vehicle 105 and/or the trailer 110 do not slid. By independently controlling rotation angle and torque of each trailer wheel 115, the electric towing system 120 may ensure that the trailer 110 “follows” the path of the vehicle 105 and does not waver, thus enhancing vehicle operator's convenience while towing the trailer 110.

The electric towing system 120 may be further configured to switch OFF or deactivate the trailer wheel drive motor (and hence may cause the trailer 110 to not use power drawn from the trailer batteries) when the vehicle 105 and the trailer 110 may be travelling on a downgraded road (e.g., downhill). In this case, if the trailer 110 includes regenerative braking mode, the trailer 110 may harvest kinetic power and store the harvested power in the trailer batteries. In some aspects, the trailer 110 may also transfer power from the trailer batteries to the vehicle batteries, when the vehicle batteries have low SoC or when the vehicle operator instructs the electric towing system 120 to transfer power from the trailer batteries to the vehicle batteries.

In the aspect described above (i.e., when the vehicle 105 and the trailer 110 are travelling on a downgraded road), if the vehicle 105 too includes regenerative braking mode, the vehicle 105 may harvest kinetic power and store the power in the vehicle batteries.

In further aspects, the electric towing system 120 may be configured to switch OFF the trailer wheel drive motor when the SoC of the trailer batteries is below a predetermined threshold. In yet another aspect, the electric towing system 120 may be configured to switch OFF the trailer wheel drive motor when the one or more predefined conditions described above cease. For example, if the electric towing system 120 switched ON the trailer wheel drive motor when the vehicle batteries may have had low SoC, the electric towing system 120 may switch OFF the trailer wheel drive motor when the vehicle batteries may be charged again.

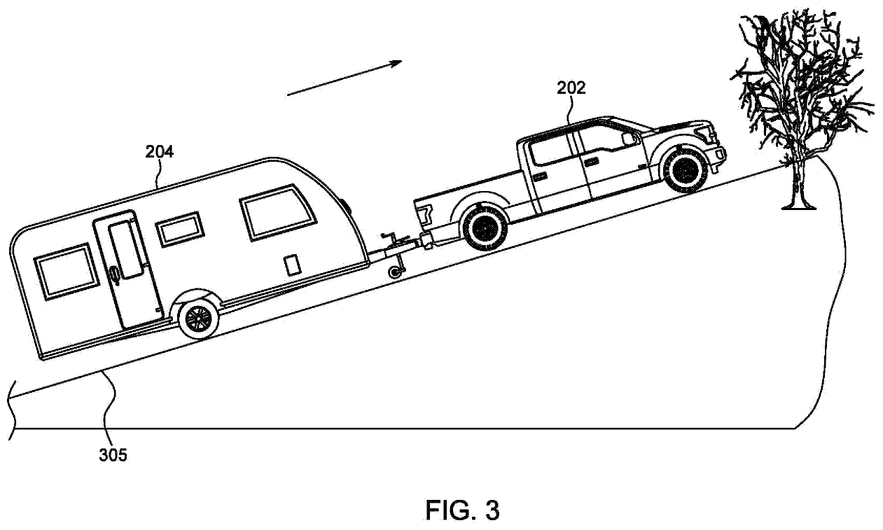

FIG. 2 depicts an example system 200 for controlling the trailer 110 attached to the vehicle 105 in accordance with the present disclosure. While describing FIG. 2, references may be made to FIGS. 3-6.

The system 200 may include a towing vehicle 202 (or a vehicle 202), a trailer 204, an electric towing system 206, and a user device 208 communicatively connected with each other via one or more networks 210. The vehicle 202 may be same as the vehicle 105, the trailer 204 may be same as the trailer 110, and the electric towing system 206 may be same as the electric towing system 120. The electric towing system 206, as described herein, can be implemented in hardware, software (e.g., firmware), or a combination thereof. Further, as described in conjunction with FIG. 1, the electric towing system 206 may be part of the vehicle 202, the trailer 204 or a remote server (not shown).

The user device 208 may be associated with a vehicle 202 operator (not shown). The user device 208 may be, for example, a mobile phone, a laptop, a computer, a tablet, or any other similar device with communication capabilities.

The network(s) 210 illustrates an example communication infrastructure in which the connected devices discussed in various embodiments of this disclosure may communicate. The network(s) 210 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 202 may include a plurality of units including, but not limited to, a vehicle transceiver 212, one or more vehicle sensors 214, a vehicle memory 216, one or more vehicle Electronic Control Units (ECUs) 218, one or more vehicle batteries 220, and a vehicle wheel control unit 222.

The vehicle transceiver 212 may be configured to transmit/receive information, data, instructions, etc. to/from one or more external devices via the network 210. For example, the vehicle transceiver 212 may transmit/receive information data, instructions, etc. to/from the trailer 204, the electric towing system 206 and the user device 208 via the network 210.

The vehicle sensors 214 may include sensors including, but not limited to, a Radio Detection and Ranging (RADAR or “radar”) sensor, sitting area buckle sensors, sitting area sensors, a Light Detecting and Ranging (LiDAR or “lidar”) sensor, door sensors, interior and exterior vehicle cameras, proximity sensors, temperature sensors, an ambient weather sensor, a road condition sensor, a road grade sensor, etc. In some aspects, the road condition sensor may be configured to determine whether the vehicle 202 may be travelling on a smooth road or a challenging road, e.g., a road having a presence of snow, mud, sand, ruts, etc. The road grade sensor may be configured to determine whether the vehicle 202 may be travelling on a level road, a downgraded road or an upgraded road.

The vehicle sensors 214 may send sensory inputs to the vehicle transceiver 212, which may transmit the inputs to the external devices via the network 210. The vehicle sensors 214 may further send the sensory inputs to the vehicle memory 216 for storage purpose.

The vehicle ECUs 218 may be configured to determine vehicle 202 operational status including, but not limited to, vehicle weight (including weight of vehicle occupants and/or cargo), vehicle batteries 220 health status, vehicle batteries 220 temperature, vehicle batteries 220 state of charging (SOC), vehicle range, and/or the like. The vehicle ECUs 218 may send the determined vehicle 202 operational status to the external devices via the network 210 and the vehicle transceiver 212 periodically (e.g., at a predefined frequency). Further, the vehicle ECUs 218 may send the determined vehicle 202 operational status to the vehicle memory 216 for storage purpose.

The vehicle wheel control unit 222 may be configured to determine vehicle 202 movement status including, but not limited to, torque, rotation and movement direction of each vehicle 202 wheel. The vehicle wheel control unit 222 may send the determined vehicle 202 movement status to the external devices via the network 210 and the vehicle transceiver 212 periodically (e.g., at a predefined frequency). Further, the vehicle wheel control unit 222 may send the determined vehicle 202 movement status to the vehicle memory 216 for storage purpose.

The vehicle memory 216 may be a non-transitory computer-readable memory. The vehicle memory 216 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

In some aspects, the vehicle memory 216 may be configured to store road information as determined by the vehicle sensors 214, and vehicle information as determined by the vehicle ECUs 218 and the vehicle wheel control unit 222. The road information may include, for example, road grade information (e.g., whether the vehicle 202 is travelling on a downgraded, an upgraded or a level road) and road condition information (e.g., whether the vehicle 202 is travelling on a challenging road including mud, snow, rut, sand, etc.). The vehicle information may include, for example, vehicle weight, vehicle batteries 220 SoC, and torque, rotation angle and movement direction for each vehicle wheel, wheel pressure of each vehicle wheel, etc. In some aspects, the vehicle memory 216 may additionally store information associated with vehicle wheel design, overall vehicle design (e.g., whether the vehicle 202 is aerodynamic), presence (or absence) of regenerative braking mode in the vehicle 202, etc., as part of the vehicle information.

In additional aspects, the vehicle information may include information associated with historical vehicle usage or drive/travel pattern. For example, the vehicle memory 216 may store information associated with typical weight (e.g., of passenger or cargo) carried by the vehicle 202, typical road network travelled by the vehicle 202, typical road condition and/or grade information of the road network travelled by the vehicle 202, typical travel time durations, etc.

The vehicle batteries 220 may be configured to provide power to one or more vehicle components and/or to the external devices, to drive operation of the vehicle components and/or the external devices.

Similar to the vehicle 202, the trailer 204 may include a plurality of units including, but not limited to, a trailer transceiver 224, one or more trailer sensors 226, a trailer memory 228, one or more trailer batteries 230, a trailer wheel control unit 232, a trailer wheel drive motor 234, and a trailer wheel steering actuator 236. The trailer transceiver 224 may be configured to transmit/receive information, data, instructions, etc. to/from one or more external devices via the network 210. For example, the trailer transceiver 224 may transmit/receive information data, instructions, etc. to/from the vehicle 202, the electric towing system 206 and the user device 208 via the network 210.

The trailer sensors 226 may include sensors similar to the vehicle sensors 214. Specifically, in some aspects, the trailer sensors 226 may also include its independent ambient weather sensor, a road condition sensor, and a road grade sensor. The trailer sensors 226 may also include weight sensors configured to determine trailer weight and weight of cargo, passenger, accessories, etc. in the trailer 204. The trailer sensors 226 may further include battery state sensors that may be configured to determine trailer batteries 230 SoC, trailer batteries 230 health status, trailer batteries 230 temperature, and/or the like. The trailer sensors 226 may additionally include wheel status sensors configured to determine wheel torque and rotation angle of each trailer wheel.

The trailer sensors 226 may send the measured inputs described above to the external devices via the network 210 and the trailer transceiver 224 periodically (e.g., at a predefined frequency). Further, the trailer sensors 226 may send the measured inputs to the trailer memory 228 for storage purpose.

The trailer memory 228 may be similar to the vehicle memory 216, and may be configured to store the inputs measured by the trailer sensors 226 as “trailer information”. The trailer information may further include wheel design of each trailer wheel, overall trailer design, information associated with presence (or absence) of regenerative braking mode in the trailer 204, etc.

As described in conjunction with FIG. 1, each trailer 204 wheel may have an associated independent trailer wheel drive motor 234 and trailer wheel steering actuator 236. The trailer wheel drive motor 234 may control movement (e.g., speed or torque) of a trailer 204 wheel (or “drive” the trailer 204 wheel), and the trailer wheel steering actuator 236 may control rotation angle of the trailer 204 wheel. Although FIG. 2 depicts a single trailer wheel drive motor 234 and a single trailer wheel steering actuator 236, the trailer 204 may include two or four separate motors and actuators (e.g., a motor and an actuator for each trailer 204 wheel), based on whether the trailer 204 has two or four wheels (or any other count of wheels).

The trailer wheel control unit 232 may be configured to control operation of each trailer wheel drive motor 234 and trailer wheel steering actuator 236. For example, the trailer wheel control unit 232 may activate or deactivate the trailer wheel drive motor 234, or may change rotation angle of each trailer 204 wheel by controlling the trailer wheel steering actuator 236. The trailer wheel control unit 232 may be further configured to control flow of power to the trailer wheel drive motor 234 and the trailer wheel steering actuator 236. Specifically, the trailer wheel control unit 232 may enable the trailer wheel drive motor 234 and the trailer wheel steering actuator 236 to draw power from the vehicle batteries 220 or the trailer batteries 230. The trailer wheel control unit 232 may control operation of the trailer wheel drive motor 234 and the trailer wheel steering actuator 236, and the flow of power, based on one or more predefined conditions that are described later in the description below.

The trailer batteries 230 may be configured to power the operation of the trailer wheel drive motor 234 and the trailer wheel steering actuator 236. In addition, the trailer batteries 230 may provide power for the operation of one or more trailer accessories (e.g., air conditioning, heater, power windows, etc.). In further aspects, the trailer batteries 230 may be configured to transfer power to the vehicle batteries 220 and/or power one or more vehicle 202 units, based on one or more predefined conditions (description below).

A person ordinarily skilled in the art may appreciate that the architecture of the vehicle 202 and the trailer 204 shown in FIG. 2 may omit certain vehicle and trailer units and/or computing modules. It should be readily understood that the vehicle 202 and the trailer 204 depicted in FIG. 2 is an example of a possible implementation according to the present disclosure, and thus, it should not be considered limiting or exclusive.

As described above, the electric towing system 206 (“system 206”) may communicatively connect with the vehicle 202, the trailer 204 and the user device 208 via the network 210. The system 206 may include a system transceiver 238, a system processor 240, and a system memory 242. The system transceiver 238 may be configured to transmit/receive data, information, instructions, etc. to/from one or more external devices via the network 210. For example, the system transceiver 238 may transmit/receive data, information, instructions, etc. to/from the vehicle 202, the trailer 204 and the user device 208.

The system processor 240 may be an Artificial Intelligence (AI) based processor that may be disposed in communication with one or more memory devices (e.g., the system memory 242 and/or one or more external databases not shown in FIG. 2). The system processor 240 may utilize the system memory 242 to store programs in code and/or to store data for performing various system 206 operations in accordance with the present disclosure. The system memory 242 may be a non-transitory computer-readable memory. The system memory 242 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

The system memory 242 may include one or more databases including, but not limited to, a vehicle information database 244, a trailer information database 246 and a road information database 248. The vehicle information database 244 may be configured to store the vehicle 202 information, the trailer information database 246 may be configured to store the trailer 204 information, and the road information database 248 may be configured to store road information (e.g., road grade information and road condition information) of road on which the vehicle 202 and the trailer 204 may be travelling.

In operation, the system transceiver 238 may be configured to receive the vehicle 202 information (that may be stored in the vehicle memory 216, as described above) from the vehicle transceiver 212. The system transceiver 238 may receive the vehicle 202 information at a predefined frequency, e.g., every 0.5 or 1 second. Similarly, the system transceiver 238 may be configured to receive the trailer 204 information (that may be stored in the trailer memory 228, as described above) from the trailer transceiver 224. The system transceiver 238 may receive the trailer 204 information too at a predefined frequency, e.g., every 0.5 or 1 second. In a similar manner, the system transceiver 238 may receive sensory inputs (including road information, weather information, etc.) from the vehicle sensors 214 and the trailer sensors 226 via respective vehicle transceiver 212 and trailer transceiver 224.

The system transceiver 238 may send the received vehicle 202 information, the trailer 204 information and the road information of the road on which the vehicle 202 and the trailer 204 may be traveling to respective system memory 242 databases (i.e., the vehicle information database 244, the trailer information database 246 and the road information database 248). In addition, the system transceiver 238 may send the received vehicle 202 information, the trailer 204 information and the road information to the system processor 240.

Responsive to obtaining the vehicle 202 information, the trailer 204 information and the road information from the system transceiver 238, the system processor 240 may analyze the obtained information and implement an AI-based algorithm (that may be stored in the system memory 242) to determine whether a first predefined condition is met based on the obtained information. In some aspects, the system processor 240 may implement the AI-based algorithm at a predefined frequency (e.g., every 0.5 or 1 second), or as and when the system processor 240 determines a change in vehicle 202 condition, trailer 204 condition, and/or road information. For example, the system processor 240 may implement the AI-based algorithm when there may be a change in vehicle 202 or trailer 204 weight, when road condition information indicates that the vehicle 202 and the trailer 204 may have started to travel on a road having presence of snow, mud, sand, etc., when road grade information indicates that the vehicle 202 and the trailer 204 may have started to travel on an upgraded or a downgraded road, and/or the like.

Different examples of “first predefined condition” are described below. The examples are provided for illustrative purpose, and should not be construed as limiting the present disclosure scope.

In one exemplary aspect, the system processor 240 may determine that the first predefined condition may be met when the obtained road information indicates that the vehicle 202 and the trailer 204 may be travelling on an upgraded road, as shown in FIG. 3. Specifically, FIG. 3 depicts a snapshot of the vehicle 202 and the trailer 204 travelling on an upgraded road 305 in accordance with the present disclosure. Responsive to determining that the vehicle 202 and the trailer 204 may be travelling on the upgraded road 305 (i.e., the first predefined condition may be met), the system processor 240 may transmit, via the system transceiver 238, a first command signal to the trailer wheel control unit 232 to activate the trailer wheel drive motor 234 and cause the trailer wheel drive motor 234 to operate using the trailer batteries 230.

The trailer wheel control unit 232 may receive the first command signal from the system transceiver 238, and may activate the trailer wheel drive motor 234 (and cause the trailer wheel drive motor 234 to operate using the trailer batteries 230). By activating the trailer wheel drive motor 234, the trailer wheel control unit 232 may enable the trailer 204 to move using its own power (i.e., by using the trailer batteries 230), and hence the trailer 204 may not require the “pull” from the vehicle 202 or power from the vehicle batteries 220 to move. In a way, the trailer 204 may act as an “electric vehicle” itself, when the trailer wheel control unit 232 activates the trailer wheel drive motor 234.

A person ordinarily skilled in the art may appreciate that when the vehicle 202 and the trailer 204 may be travelling on the upgraded road 305, considerable vehicle 202 power may be consumed in “pulling” the trailer 204. Therefore, by activating the trailer wheel drive motor 234 when the vehicle 202 and the trailer 204 may be travelling on the upgraded road 305, the system processor 240 may assist in conserving vehicle 202 power, thereby optimizing power consumption in the vehicle 202.

In another exemplary aspect, the system processor 240 may determine that the first predefined condition may be met when the obtained vehicle information indicates that the vehicle batteries 220 SoC may be less than a vehicle SoC threshold (that may be pre-stored in the system memory 242). In this case, the system processor 240 may determine that the first predefined condition may be met irrespective of whether the vehicle 202 and the trailer 204 are travelling on the upgraded road 305 or a level road. Stated another way, even if the road grade information indicates that the vehicle 202 and the trailer 204 may be travelling on a level road, the system processor 240 may determine that the first predefined condition is met when the vehicle batteries 220 SoC is less than the vehicle SoC threshold. Similar to the aspect described above, in this aspect as well, the system processor 240 may transmit, via the system transceiver 238, the first command signal to the trailer wheel control unit 232 to activate the trailer wheel drive motor 234 and cause the trailer wheel drive motor 234 to operate using the trailer batteries 230. A person ordinarily skilled in the art may appreciate that by activating the trailer wheel drive motor 234, the system processor 240 may assist the vehicle 202 in reducing vehicle 202 power consumption (required for towing the trailer 204) when the vehicle batteries 220 SoC may be less.

In another exemplary aspect, the system processor 240 may determine that the first predefined condition may be met when the obtained vehicle information indicates that vehicle wheel pressure of one or more vehicle wheels may be less than a wheel pressure threshold (that may be pre-stored in the system memory 242). In this case as well, the system processor 240 may transmit, via the system transceiver 238, the first command signal to the trailer wheel control unit 232 to activate the trailer wheel drive motor 234 and cause the trailer wheel drive motor 234 to operate using the trailer batteries 230.

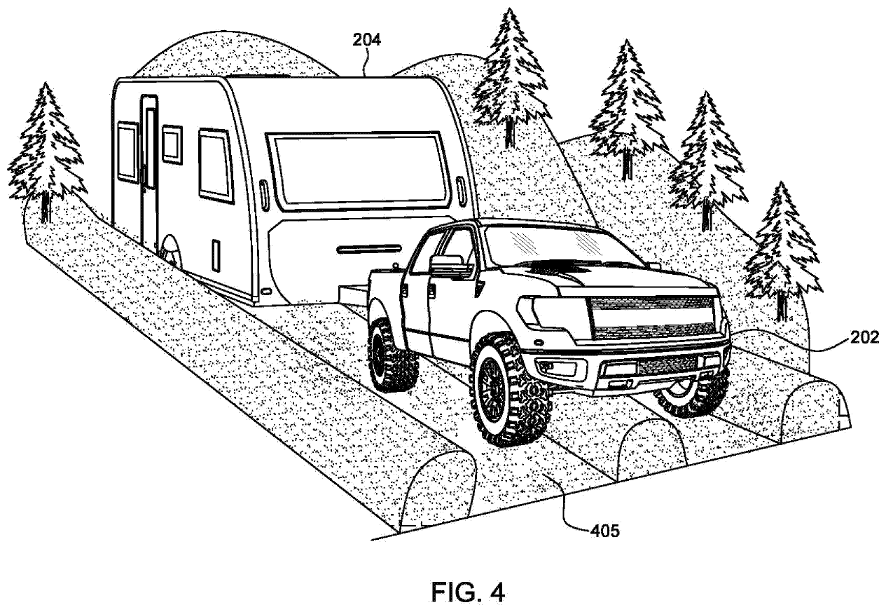

In yet another exemplary aspect, the system processor 240 may determine that the first predefined condition may be met when the obtained road information indicates that the vehicle 202 and the trailer 204 may be travelling on a road that may have a presence of mud, snow, sand, rut, liquid, etc., as shown in FIG. 4. Specifically, FIG. 4 depicts a snapshot of the vehicle 202 and the trailer 204 travelling on a challenging road 405 in accordance with the present disclosure. In this case as well, the system processor 240 may determine that the first predefined condition is met based on road condition information, irrespective of whether the vehicle 202 and the trailer 204 are travelling on an upgraded road or a level road.

Responsive to determining that the road 405 has presence of mud, snow, sand, etc., the system processor 240 may transmit, via the system transceiver 238, the first command signal to the trailer wheel control unit 232 to activate the trailer wheel drive motor 234 and cause the trailer wheel drive motor 234 to operate using the trailer batteries 230.

A person ordinarily skilled in the art may appreciate that “pulling” the trailer 204 on a road having snow, mud, sand, etc., may cause significant drag on the vehicle 202 and consume considerable vehicle 202 power. Therefore, by activating the trailer wheel drive motor 234, the system processor 240 may assist in conserving vehicle 202 power.

In further aspects, when the system processor 240 determines that the vehicle 202 and the trailer 204 may be travelling on the road 405, the system processor 240 may transmit, via the system transceiver 238, a second command signal to the trailer wheel control unit 232 to control torque and rotation angle of each trailer wheel, so that the trailer 204 may stably “follow” vehicle 202 movement and does not skid or waver. Specifically, the system processor 240 may determine torque and rotation angle of each vehicle 202 wheel from the obtained vehicle information, and may send the second command signal to the trailer wheel control unit 232 such that torque and rotation angle of each trailer 204 wheel may be aligned with (or correspond to) respective torque and rotation angle of each vehicle 202 wheel. In this case, the system processor 240 may determine optimum torque and rotation angle of each trailer wheel based on the torque and rotation angle of each vehicle 202 wheel, and may include the determined optimum torque and rotation angle of each trailer wheel in the second command signal.

Responsive to receiving the second command signal, the trailer wheel control unit 232 may control torque and rotation angle of each trailer 204 wheel, via the trailer wheel drive motor 234 and the trailer wheel steering actuator 236, such that trailer 204 wheel movement is aligned with (e.g., be same as) vehicle 202 wheel movement. By aligning the trailer 204 wheel movement with the vehicle 202 wheel movement, the system processor 240 may ensure that the vehicle 202 and the trailer 204 stably move on the road 405.

In yet another exemplary aspect, when the road information indicates that the vehicle 202 and the trailer 204 may be travelling on a level road, the system processor 240 may determine whether it may be optimum to activate the trailer wheel drive motor 234, based on the obtained vehicle 202 information and the trailer 204 information. For example, the system processor 240 may transmit, via the system transceiver 238, the first command signal to the trailer wheel control unit 232 to activate the trailer wheel drive motor 234 when the road information indicates level road and when the trailer 204 weight (as determined from the trailer 204 information) is greater than a trailer weight threshold (that may be pre-stored in the system memory 242). Stated another way, the system processor 240 may determine that the first predefined condition may be met when the trailer 204 weight is greater than the trailer weight threshold, and when the vehicle 202 and the trailer 204 are travelling on a level road. In this case as well, the system processor 240 may conserve vehicle 202 power consumption by activating the trailer wheel drive motor 234, as “pulling” a heavy trailer 204 may cause a significant drag on the vehicle 202.

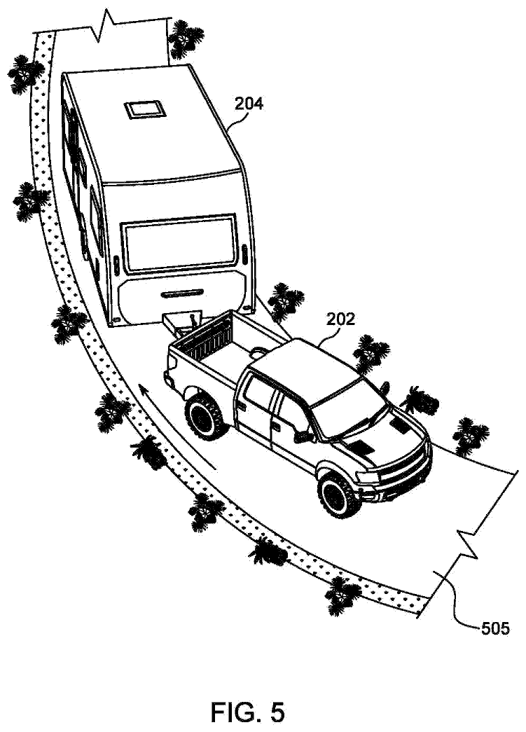

In another aspect, the system processor 240 may determine that the first predefined condition may be met when the vehicle 202 information (specifically, movement direction of each vehicle 202 wheel) indicates that the vehicle 202 may be performing vehicle backing operation. Stated another way, the system processor 240 may determine that the first predefined condition may be met when the vehicle 202 and the trailer 204 may be reversing, as shown in FIG. 5. Specifically, FIG. 5 depicts a snapshot of the vehicle 202 and the trailer 204 executing a backing operation on a narrow road 505 in accordance with the present disclosure.

Responsive to determining that the vehicle 202 may be performing backing operation, the system processor 240 may transmit, via the system transceiver 238, the first command signal to the trailer wheel control unit 232 to activate the trailer wheel drive motor 234. In addition, in this case, the system processor 240 may transmit, via the system transceiver 238, the second command signal to the trailer wheel control unit 232 to control torque and rotation angle of each trailer 204 wheel, so that the trailer 204 may stably “follow” vehicle 202 backing movement (specifically, vehicle 202 wheel movement) and does not waver on the narrow road 505.

A person ordinarily skilled in the art may appreciate that reversing the vehicle 202 and the trailer 204 on the narrow road 505 may be a challenge for a vehicle 202 user. Therefore, by controlling torque and rotation angle of each trailer 204 wheel such that it “follows” the vehicle 202 wheel movement, the system processor 240 may enhance user convenience when the user reverses the vehicle 202 and the trailer 204.

In some aspects, the system processor 240 may transmit, via the system transceiver 238, the first command signal to the trailer wheel control unit 232 to activate the trailer wheel drive motor 234 and cause the trailer wheel drive motor 234 to operate using the trailer batteries 230, based on vehicle 202 user inputs. For example, in a scenario where the user may desire to conserve power in the vehicle batteries 220, the user may transmit a request to the system transceiver 238, via the user device 208 or a vehicle 202 HMI (not shown) and the network 210, to activate the trailer wheel drive motor 234 and cause the trailer wheel drive motor 234 to operate using the trailer batteries 230. In this case, the system processor 240 may obtain the request from the system transceiver 238, and may transmit the first command signal to the trailer wheel control unit 232 responsive to obtaining the request.

In additional aspects, the system processor 240 may transmit, via the system transceiver 238, the first command signal to the trailer wheel control unit 232 to activate the trailer wheel drive motor 234 based on historical vehicle 202 usage or drive/travel pattern (which may be part of the vehicle 202 information). Specifically, the system processor 240 may “predict” vehicle 202 usage for a future time (e.g., next 6 hours, 12 hours or 24 hours) based on historical vehicle 202 usage or drive/travel pattern, and may activate the trailer wheel drive motor 234 to conserve vehicle 202 power if the predicted vehicle 202 usage indicates substantial vehicle 202 power usage. For example, if the system processor 240 predicts a long drive for the vehicle 202 for next 12 hours (based on historical vehicle 202 usage or drive/travel pattern), the system processor 240 may activate the trailer wheel drive motor 234 to conserve vehicle 202 power.

In further aspects, the system processor 240 may transmit, via the system transceiver 238, the first command signal to the trailer wheel control unit 232 to activate the trailer wheel drive motor 234 based ambient weather conditions. For example, if the system processor 240 determines that inclement weather condition (e.g., rain, storm, hot/cold weather, etc.) may be present in proximity to the vehicle 202 based on sensory inputs received from vehicle or trailer ambient weather sensor, the system processor 240 may activate the trailer wheel drive motor 234 to conserve vehicle 202 power. A person ordinarily skilled in the art may appreciate that “pulling” the trailer 204 in inclement weather conditions may cause significant drag on the vehicle 202 and may hence consume considerable vehicle 202 power. Therefore, by activating the trailer wheel drive motor 234 in inclement weather conditions, the system processor 240 may assist in conserving vehicle 202 power.

The system processor 240 may be further configured to transmit, via the system transceiver 238, a third command signal to the trailer wheel control unit 232 to deactivate the trailer wheel drive motor 234 when a second predefined condition is met. In some aspects, deactivating the trailer wheel drive motor 234 may cause the trailer 204 to not use power from the trailer batteries 230.

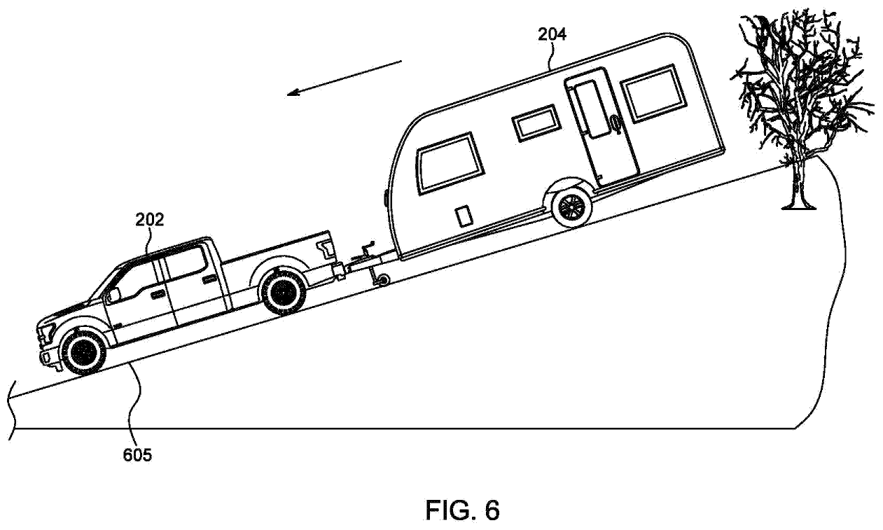

In an exemplary aspect, the system processor 240 may determine that the second predefined condition may be met when the obtained road information indicates that the vehicle 202 and the trailer 204 may be travelling on a downgraded road, as shown in FIG. 6. Specifically, FIG. 6 depicts a snapshot of the vehicle 202 and the trailer 204 travelling on a downgraded road 605 in accordance with the present disclosure. In some aspects, if the trailer 204 has presence of regenerative braking mode, the trailer 204 may harvest kinetic energy while travelling on the road 605 and store harvested power in the trailer batteries 230.

In other aspects, the system processor 240 may determine that the second predefined condition may be met when the SoC of the trailer batteries 230 may be below a predetermined threshold, or when the first predefined condition ceases, as described in conjunction with FIG. 1.

The system processor 240 may be further configured to cause transfer of stored power from the trailer batteries 230 to the vehicle batteries 220, based on user request (e.g., via the user device 208 or the vehicle 202 HMI). In other aspects, the system processor 240 may cause automatic transfer of stored power from the trailer batteries 230 to the vehicle batteries 220 when the system processor 240 determines that the vehicle batteries 220 SoC may be lower than a power transfer threshold (that may be pre-stored in the system memory 242).

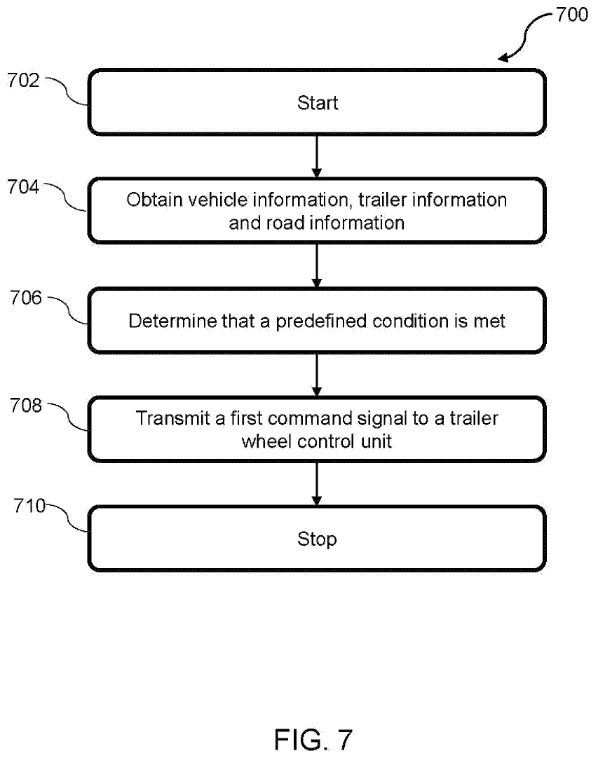

FIG. 7 depicts a flow diagram of an example method 700 for controlling trailer 204 wheels in accordance with the present disclosure. FIG. 7 may be described with continued reference to prior figures. The following process is exemplary and not confined to the steps described hereafter. Moreover, alternative embodiments may include more or less steps that are shown or described herein and may include these steps in a different order than the order described in the following example embodiments.

Referring to FIG. 7, at step 702, the method 700 may commence. At step 704, the method 700 may include obtaining, by the system processor 240, the vehicle 202 information, the trailer 204 information and the road information. At step 706, the method 700 may include determining, by the system processor 240, that the first predefined condition may be met based on the obtained vehicle 202 information, the trailer 204 information and the road information. Examples of the first predefined condition are described above in conjunction with FIG. 2.

At step 708, the method 700 may include transmitting, via the system processor 240, the first command signal to the trailer wheel control unit 232 to activate the trailer wheel drive motor 234 when the first predefined condition may be met. As described above, the trailer wheel drive motor 234 may operate by using power from the trailer batteries 230 when the trailer wheel control unit 232 activates the trailer wheel drive motor 234.

At step 710, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system to control a trailer attached to a vehicle comprising:
a transceiver configured to receive road information, vehicle information, and trailer information; and
a processor communicatively coupled with the transceiver, wherein the processor is configured to:
obtain the road information, the vehicle information, and the trailer information;
determine, based on the road information, the vehicle information, and the trailer information, that a first predefined condition is met; and
transmit, based on the first predefined condition being met, a first command signal to a trailer wheel control unit to activate a trailer wheel drive motor.

2. The system of claim 1, wherein the transceiver receives the road information from the vehicle or the trailer, the vehicle information from the vehicle, and the trailer information from the trailer.

3. The system of claim 1, wherein the trailer wheel drive motor is located in the trailer, and wherein the trailer wheel drive motor is configured to drive a trailer wheel.

4. The system of claim 1, wherein the road information comprises road grade information and road condition information.

5. The system of claim 4, wherein the first predefined condition is met when the road grade information indicates an upgraded road.

6. The system of claim 4, wherein the vehicle information comprises information associated with vehicle weight, vehicle wheel design, vehicle design, vehicle battery state of charge (SoC), wheel torque for a vehicle wheel, wheel rotation angle for the vehicle wheel, and wheel movement direction of the vehicle wheel.

7. The system of claim 6, wherein the first predefined condition is met when the road grade information indicates a level road, and when the vehicle battery SoC is less than a vehicle SoC threshold.

8. The system of claim 6, wherein the first predefined condition is met when the wheel movement direction of the vehicle wheel indicates a vehicle backing operation, and wherein the processor is further configured to transmit a second command signal to the trailer wheel control unit to control torque and rotation angle of the trailer wheel when the wheel movement direction of the vehicle wheel indicates the vehicle backing operation.

9. The system of claim 4, wherein the first predefined condition is met when the road condition information indicates a presence of mud, snow, or liquid on a road, and wherein the processor is further configured to transmit a third command signal to the trailer wheel control unit to control torque and rotation angle of the trailer wheel when the road condition information indicates the presence of mud, snow, or liquid on the road.

10. The system of claim 4, wherein the trailer information comprises information associated with trailer weight, trailer wheel design, trailer design, trailer battery state of charge (SoC), wheel torque for the trailer wheel, and wheel rotation angle for the trailer wheel.

11. The system of claim 10, wherein the first predefined condition is met when the road grade information indicates a level road, and when the trailer weight is greater than a trailer weight threshold.

12. The system of claim 4, wherein the processor is further configured to transmit a fourth command signal to the trailer wheel control unit to deactivate the trailer wheel drive motor when a second predefined condition is met.

13. The system of claim 12, wherein the second predefined condition is met when the road grade information indicates a downgraded road.

14. A method to control a trailer attached to a vehicle, comprising:
obtaining, by a processor, road information, vehicle information, and trailer information;
determining, by the processor, that a predefined condition is met based on the road information, the vehicle information, and the trailer information; and
transmitting, by the processor, a command signal to a trailer wheel control unit to activate a trailer wheel drive motor responsive to a determination that the predefined condition is met.

15. The method of claim 14, wherein the road information is obtained from the vehicle or the trailer, the vehicle information is obtained from the vehicle, and the trailer information is obtained from the trailer.

16. The method of claim 14, wherein the trailer wheel drive motor is located in the trailer, and wherein the trailer wheel drive motor is configured to drive a trailer wheel.

17. The method of claim 14, wherein the road information comprises road grade information and road condition information.

18. The method of claim 17, wherein the predefined condition is met when the road grade information indicates an upgraded road.

19. The method of claim 14, wherein the vehicle information comprises information associated with vehicle weight, vehicle wheel design, vehicle design, vehicle battery state of charge (SoC), wheel torque for a vehicle wheel, wheel rotation angle for the vehicle wheel, and wheel movement direction of the vehicle wheel.

20. A non-transitory computer-readable medium storing computer-executable instructions which when executed by one or more processors result in performing operations comprising:
obtaining road information, vehicle information, and trailer information;
determining that a predefined condition is met based on the road information, the vehicle information, and the trailer information; and
transmitting a command signal to a trailer wheel control unit to activate a trailer wheel drive motor responsive to a determination that the predefined condition is met.
